(19) United States
(12) Patent Application Publication
(10) Pub. No.: US 2011/0260602 A1
(43) Pub. Date: Oct. 27, 2011

(54) AC-PLASMA DISPLAY DEVICES USING METAL NANOPARTICLES OR NANOSTRUCTURES AND METHOD FOR MANUFACTURING THE SAME

(75) Inventors: Seong Min Lee, Daejeon (KR); Kwan Hynn Cho, Daejeon (KR); Woo Hyun Kim, Chungcheongnam-do (KR); Ki Youl Yang, Gyeongsangbuk-do (KR); Kyung Cheol Choi, Daejeon (KR)

(73) Assignee: KOREA ADVANCED INSTITUTE OF SCIENCE AND TECHNOLOGY, Daejeon (KR)

(21) Appl. No.: 12/665,082

(22) PCT Filed: Oct. 9, 2009
(86) PCT No.: PCT/KR2009/005805

§ 371 Date: Jul. 18, 2011

(30) Foreign Application Priority Data
Dec. 22, 2008 (KR) 10-2008-0130948
Dec. 29, 2008 (KR) 10-2008-0135896

(51) Int. Cl. H01J 63/04; H01J 9/24

(52) U.S. Cl. 313/491; 445/24

(57) ABSTRACT

The present invention provides an AC plasma display device using metal nanostructures, including: a front panel and a rear panel which are disposed in parallel to each other and at least one of which is provided with electrodes for gas discharge; an electrode layer, a front dielectric layer and a protective film which are sequentially formed on a side of the front panel which faces the rear panel; a phosphor layer which is formed on the rear panel and which is excited and simultaneously radiated by gas discharge occurring in the electrodes; and metal nanostructures included in the protective film and the phosphor layer, and provides a method of manufacturing the same. The AC plasma display device can improve a secondary electron emission coefficient and photoluminescent intensity using surface plasmon excitation because it is provided with a protective film including metal nanostructures.

### BACKGROUND OF THE INVENTION

1. Field of the Invention

The present invention relates to an AC plasma display device, such as an AC plasma lamp, an AC plasma display panel or the like, using plasma discharge, and a method of manufacturing the same.

2. Description of the Related Art

An AC plasma lamp or an AC plasma display panel (hereinafter, referred to as an “AC PDP”) displays an image because vacuum ultraviolet rays having a wavelength of 140˜180 nm, which are generated when an inert gas mixture, such as He+Xe, Ne+Xe or the like, is discharged in partitioned discharge cells, cause a phosphor to emit light.

FIGS. 1 and 2 are perspective views showing general AC plasma display devices, wherein FIG. 1 shows a flat AC plasma lamp 10, and FIG. 2 shows a flat AC plasma display panel 30. Though these display devices have in common the fact that they are display devices using plasma discharge, they differ from each other in structural aspect.

As shown in FIG. 1, the flat AC plasma lamp 10 includes a front panel 11 and a rear panel 17. The front panel 11 is provided with bus electrodes 12 and ITO electrodes including scan electrodes 13 and sustain electrodes 14, and these electrodes are sequentially provided thereon with a dielectric layer 15 and a magnesium oxide (MgO) protective film. The rear panel 17 is provided thereon with a dielectric layer 18, and the dielectric layer 18 is formed thereon with a phosphor layer 20. Furthermore, the phosphor layer 20 is formed on both lateral sides thereof with partition walls 19.

In this flat AC plasma lamp 10, the front panel 11 and the rear panel 17 are assembled and sealed, and then a discharge gas is charged in the assembled panels to form a discharge space, thus causing lamp discharge.

In contrast, the flat AC plasma display panel 30 has a similar structure to the flat AC plasma lamp 10 due to the fact that it also includes a front panel 31 and a rear panel 37, as shown in FIG. 2. However, the flat AC plasma display panel 30 is different from the flat AC plasma lamp 10 in the point that address electrodes 38 are disposed between the rear panel and a dielectric panel 39 such that they are at right angles to bus, scan and sustain electrodes 32, 33 and 34 provided in the front panel 31. Further, the flat AC plasma display panel 30 is different from the flat AC plasma lamp 10 in the point that each cell is divided into microcells by partition walls 40. The flat AC plasma display panel 30 further includes an oxide protection layer 36, a dielectric layer 35, and a phosphor layer 41.

In this flat AC plasma display panel 30, the front panel 31 and rear panel 37 are assembled and sealed such that the scan and sustain electrodes 33 and 34 of the front panel 31 are at right angles to the address electrodes 38 of the rear panel 37, and then a discharge gas is charged in the assembled panels to form discharge spaces in every cell.

In the above-mentioned flat AC plasma lamp 10 or flat AC plasma display panel 30, a structural method of increasing sustain gaps was introduced in order to improve its discharge efficiency. Here, the “sustain gap” refers to the gap between the sustain electrode and the scan electrode. It is known that the efficiency of plasma discharge is increased with the increase of the sustain gap. In addition to this method, a method of improving its discharge efficiency by increasing the height of the partition walls and thus enlarging the discharge space is being attempted.

Meanwhile, research for preparing a phosphor having higher luminescent efficiency by changing the composition thereof is commonly being conducted. Further, research for increasing the luminescent efficiency of a phosphor by forming a phosphor having a small particle size and thus increasing the light-absorbing surface area and light-emitting surface area of a phosphor is also being attempted. However, the luminescent efficiency of the phosphors produced through such attempts is not actually greater than that of commonly-used phosphors. Moreover, methods of surface-treating a phosphor by coating the phosphor with silicon oxide (SiO₂) or the like to prevent the deterioration of the phosphor are being attempted, and efforts to prevent the agglomeration of a phosphor and improve the performance of the phosphor by coating the phosphor with a polymer are being continuously made.

Further, in order to improve the properties of a magnesium oxide (MgO) protective film, technologies for affecting the energy level of a protective film by doping the protective film with MgO are being proposed. However, since these technologies do not increase the emission rate of secondary electrons to the MgO-doped protective film, they are problematic in that it is difficult to reduce the consumption of power by decreasing discharge voltage and increasing luminescent efficiency.

### SUMMARY OF THE INVENTION

Accordingly, the present invention has been made to solve the above-mentioned problems, and an object of the present invention is to provide an AC plasma display device in which metal nanoparticles, such as Ag nanoparticles, Au nanoparticles, Cu nanoparticles, Al nanoparticles or the like, are applied to a phosphor and an oxide protective film constituting the AC plasma display device to improve the luminescent efficiency of the AC plasma display device, so that the power consumption of the AC plasma display device is decreased and the brightness thereof is increased, thereby greatly improving the efficiency of the AC plasma display device.

In order to accomplish the above object, an aspect of the present invention provides an AC plasma display device, including: a front panel and a rear panel which are disposed in parallel to each other and at least one of which is provided with electrodes for gas discharge; an electrode layer, a front dielectric layer and a protective film which are sequentially formed on a side of the front panel which faces the rear panel; a phosphor layer which is formed on the rear panel and which is excited and simultaneously radiated by gas discharge occurring in the electrodes; and metal nanostructures included in the protective film and the phosphor layer.

Another aspect of the present invention provides an AC plasma display device, including a front panel and a rear panel disposed in parallel to each other, wherein at least one of the front panel and the rear panel is provided with electrodes for gas discharge, the rear panel is provided with a phosphor excited and simultaneously radiated by gas discharge occurring in the electrodes, and the phosphor layer is provided with metal nanostructures for improving the luminescent characteristics of a phosphor.

Still another aspect of the present invention provides an AC plasma display device, including a front panel and a rear panel disposed in parallel to each other, wherein the front panel is provided with a plurality of electrodes disposed in parallel to each other, a front dielectric layer and a protective film are sequentially formed on the plurality of electrodes, the rear panel is sequentially provided thereon with a rear dielectric layer and partition walls, a phosphor layer is formed in a space between the rear dielectric layer and the partition walls such that the phosphor layer is excited and simultaneously radiated by the gas discharge occurring in the plurality of electrodes, and the phosphor layer is provided with metal nanostructures to improve the luminescent characteristic of a phosphor.

Still another aspect of the present invention provides an AC plasma display device, including a front panel and a rear panel disposed in parallel to each other, wherein the front panel is provided with one or more electrodes, a front dielectric layer and a protective film are sequentially formed on the one or more electrodes, the rear panel is provided with electrodes such that these electrodes are at right angles to the electrodes provided in the front panel, a rear dielectric layer is formed on the electrodes, the rear dielectric layer is provided thereon with partition walls to form a plurality of cells, a phosphor layer is formed in a space between the rear dielectric layer and the partition walls such that the phosphor layer is excited and simultaneously radiated by the gas discharge occurring in the plurality of electrodes, and the phosphor layer is provided with metal nanostructures to improve the luminescent characteristics of a phosphor.

In this case, the front panel may be provided with two scan and sustain electrodes disposed in parallel to each other, and the rear panel may be provided with address electrodes.

Further, auxiliary electrodes may be further provided between the scan and sustain electrodes of the front panel.

The metal nanostructures may be irregularly-arranged nanoparticles. The irregularly-arranged nanoparticles may have various shapes such as a sphere, tetrahedron, hexahedron, octahedron, bar column and the like. The phosphor layer may be provided with metal nanoparticles having one shape or mixtures of metal nonoparticles having different shapes.

Further, the metal nanostructures may be nanostructures which are regularly arranged.

The metal nanostructures may be formed on the phosphor layer formed on the dielectric layer of the rear panel.

Further, the metal nanostructures may be formed between the dielectric layer and the phosphor layer of the rear panel.

Further, the metal nanostructures may be formed both on the phosphor layer formed on the dielectric layer of the rear panel and between the dielectric layer and the phosphor layer of the rear panel.

As described above, when the metal nanostructures are disposed at the upper and lower portions of the phosphor layer, a thermal evaporation method or an RF sputtering method may be used. In this method, heat treatment is performed in order to determine the shapes and intervals therebetween of the metal nanostructures after the deposition of a metal source. In this case, the heat treatment may be performed at a temperature of 100˜700° C., and the sizes and intervals therebetween of the metal nanostructures are determined depending on the temperature and time of the heat treatment.

Further, the metal nanostructures may be mixed with a phosphor and then provided in the phosphor layer. Specifically, the metal nanostructures can be mixed with the phosphor by dispersing the metal nanostructures in an organic solvent in the form of colloidal particles and then mixing the dispersed metal nanostructures with phosphor paste to form phosphor paste containing the metal nanostructures. In this case, the organic solvent used to disperse the metal nanostructures may be identical to an organic solvent used to prepare the phosphor paste or may have the same polarity as the organic solvent used to prepare the phosphor paste. Further, a surfactant may be used in order to prevent the agglomeration of the metal nanostructures. The phosphor paste containing the metal nanostructures may be applied using the same method as the method of applying paste in a PDP manufacturing process. In the final step of applying the phosphor paste containing the metal nanostructures, it is preferred that the metal nanostructure be adjacent to the surface of a phosphor.

Still another aspect of the present invention provides an AC plasma display device using metal nanostructures, including: a front panel and a rear panel which are spaced apart from each other at a predetermined interval and face each other and each of which is provided therein with discharge cells divided by partition walls; and an electrode layer, a front dielectric layer and a protective film which are sequentially formed on a side of the front panel which faces the rear panel, wherein the protective film is provided with metal nanostructures.

The metal nanostructures may be made of Al or one or more transition metals selected from among Cu, Ag, Au, Ni, Pt, Co, Fe, Mn, Cr, Ti, Sc and combinations thereof.

The metal nanoparticles may have a diameter of from several nanometers to several hundreds of nanometers, and may have the same area as that of a circle having a diameter of from several nanometers to several hundreds of nanometers.

A plurality of protective films may be sequentially formed on the front dielectric layer, and nanoparticle layers in which metal nanoparticles are distributed may be respectively formed between the plurality of protective films.

More specifically, the front dielectric layer may be provided thereon with a first protective film, the first protective film may be provided thereon with a nanoparticle layer in which metal nanoparticles are distributed, and the nanoparticle layer may be provided thereon with a second protective film.

In this case, the second protective film may have a thickness of 5˜200 nm.

The metal nanostructures may be distributed such that the value obtained by dividing the total area of the metal nanostructures distributed on the protective film by the total area of the protective film is in a rage of 0.01 to 10%.

The metal nanostructures may have a spherical or polyhedral shape, and the protective film may be provided with metal nanostructures having any one of the spherical and polyhedral shapes or mixtures of metal nanostructures having the spherical or polyhedral shape.

The nanoparticle layer composed of the metal nanostructures may be configured such that the nanoparticle layer optically absorbs neon (Ne) and infrared (IR) generated at the time of plasma discharge and thus increases the temperature of a region adjacent to the nanoparticle layer to increase a secondary electron emission coefficient and exo-electron emission rate.

Still another aspect of the present invention provides a method of manufacturing an AC plasma display device using metal nanostructures, in which discharge cells are formed by dividing a space between a front panel and a rear panel by partition walls, including the steps of: sequentially forming an electrode layer and a front dielectric layer on the front panel; forming a first protective film on the front dielectric layer; forming a nanoparticle layer on the first protective film by distributing metal nanostructures thereonto; and forming a second protective film on the nanoparticle layer.

In the step of forming the nanoparticle layer, the nanoparticle layer may be formed using any one of a thermal evaporation method and an RF sputtering method.

In the step of forming the nanoparticle layer, the metal nanostructures may be distributed such that the value obtained by dividing the total area of the metal nanostructures distributed on the protective film by the total area of the protective film is in a range of 0.01 to 10%.

After the step of forming the second protective film, the nanoparticle layer may be formed into a multi-layered nanoparticle layer by repetitively performing the step of forming the nanoparticle layer and the step of forming the second protective film n times, thus improving secondary electron emission coefficient using plasmon excitation.

The AC plasma display device and method of manufacturing the same according to the present invention are advantageous as follows.

According to the present invention, since the luminescent characteristics of a phosphor can be improved using irregularly-arranged metal nanoparticles or regularly-arranged metal nanostructures, the brightness of an AC plasma display device, such as an AC plasma lamp, an AC plasma display panel or the like, can be improved.

That is, according to the present invention, a surface plasmon resonance phenomenon can be induced using metal nanoparticles or metal nanostructures without changing the composition of a phosphor to improve the luminescent characteristics of the phosphor, so that the manufacturing cost of an AC plasma display device can be decreased and the luminescent efficient thereof can be improved, with the result that the power consumption of the AC plasma display device can be decreased and the brightness thereof can be improved, thereby improving the efficiency of the AC plasma display device.

Further, according to the present invention, since a metal nanoparticle layer composed of Ag, Au, Cu, Al or the like is additionally formed on a protective film of a front panel, the secondary electron emission rate of an AC plasma display device can be increased by the surface plasmon excitation induced around the metal nanoparticles under the influence of photons, such as vacuum ultraviolet (VUV), infrared (IR), visible ray or the like, generated from discharge cells, so that the driving voltage of the AC plasma display device can be decreased and the discharge efficiency thereof can be improved.

That is, according to the present invention, when photons are incident on a protective film (MgO) including metal nanoparticles, the excitation of electrons is accelerated by the strong local field generated around the metal nanoparticles, thus increasing the secondary electron emission coefficient of the protective film (MgO), so that the secondary electron emission coefficient in discharge cells is also increased, with the result that the driving voltage of the AC plasma display device is decreased and the discharge efficiency thereof is improved, thereby realizing a high-efficiency AC plasma display panel.

Furthermore, according to the present invention, a metal nanoparticle layer formed in a protective film functions to optically absorb the neon (Ne) and infrared (IR) generated at the time of plasma discharge and thus to store the energy generated from the plasma discharge in metal nanoparticles and to increase the temperature of the region adjacent to the nanoparticle layer, so that the secondary electron emission coefficient and exo-electron emission rate of the AC plasma display device are increased, with the result that the address delay time thereof is decreased, thereby realizing a high-resolution AC plasma display panel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a conventional AC plasma lamp;

FIG. 2 is a perspective view showing a conventional AC plasma display panel having three kinds of electrodes;

FIG. 3 is a perspective view showing an AC plasma lamp including a phosphor layer provided with metal nanoparticles according to the present invention;

FIG. 4 is a perspective view showing an AC plasma display panel having three kinds of electrodes, which includes a phosphor layer provided with metal nanoparticles according to the present invention;

FIGS. 5 to 8 are sectional views showing various structures in which phosphor layers are provided with metal nanoparticles according to embodiments of the present invention, wherein FIG. 5 shows a structure in which a phosphor layer is provided at the upper side thereof with metal nanoparticles, FIG. 6 shows a structure in which a phosphor layer is provided at the lower side thereof with metal nanoparticles, FIG. 7 shows a structure in which a phosphor layer is provided at both the upper and lower sides thereof with metal nanoparticles, and FIG. 8 shows a structure in which a phosphor layer is provided at the interior side thereof with the metal nanoparticles;

FIGS. 9 to 12 are sectional views showing various structures in which phosphor layers are provided with metal nanostructures according to embodiments of the present invention, wherein FIG. 9 shows a structure in which a phosphor layer is provided at the upper side thereof with metal nanostructures, FIG. 10 shows a structure in which a phosphor layer is provided at the lower side thereof with metal nanostructures, FIG. 11 shows a structure in which a phosphor layer is provided at both the upper and lower sides thereof with metal nanostructures, and FIG. 12 shows a structure in which a phosphor layer is provided at the interior side thereof with the metal nanostructures;

FIG. 13 is a schematic view explaining the interaction between phosphors and metal nanoparticles according to the present invention;

FIG. 14 is a perspective view showing an AC plasma display panel including a protective film provided with metal nanostructures according to the present invention;

FIG. 15 is a sectional view showing a front panel assembly including a protective film provided with metal nanostructures according to the present invention;

FIG. 16 is an exploded perspective view showing a front panel assembly including a protective film provided with metal nanostructures according to an embodiment of the present invention;

FIG. 17 is a flowchart showing a method of manufacturing an AC plasma display panel including a protective film provided with metal nanoparticles according to the present invention;

FIG. 18 is an exploded perspective view showing a front panel assembly including a protective film provided with metal nanostructures according to another embodiment of the present invention; and

FIG. 19 is a perspective view showing an AC plasma display panel in which both a phosphor layer and a protective film are provided with metal nanoparticles according to the present invention.

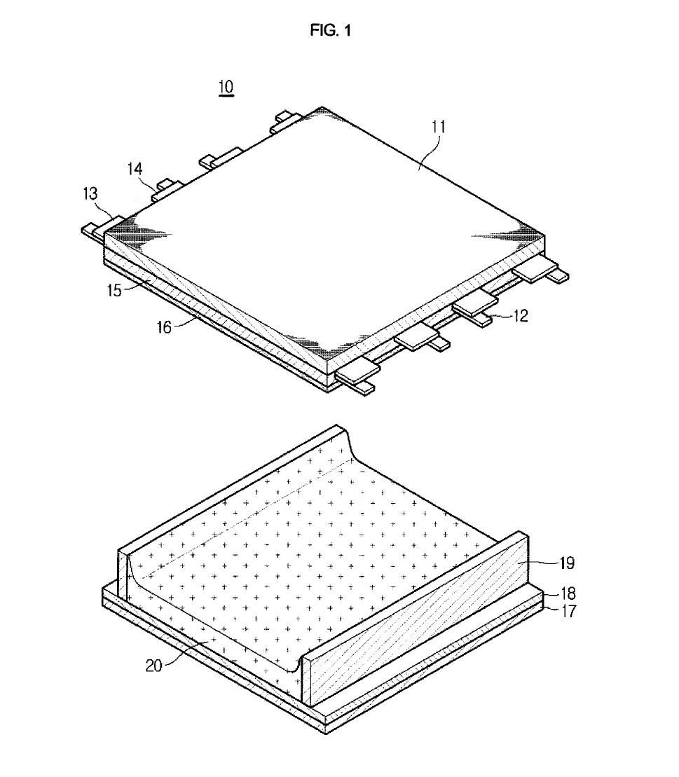

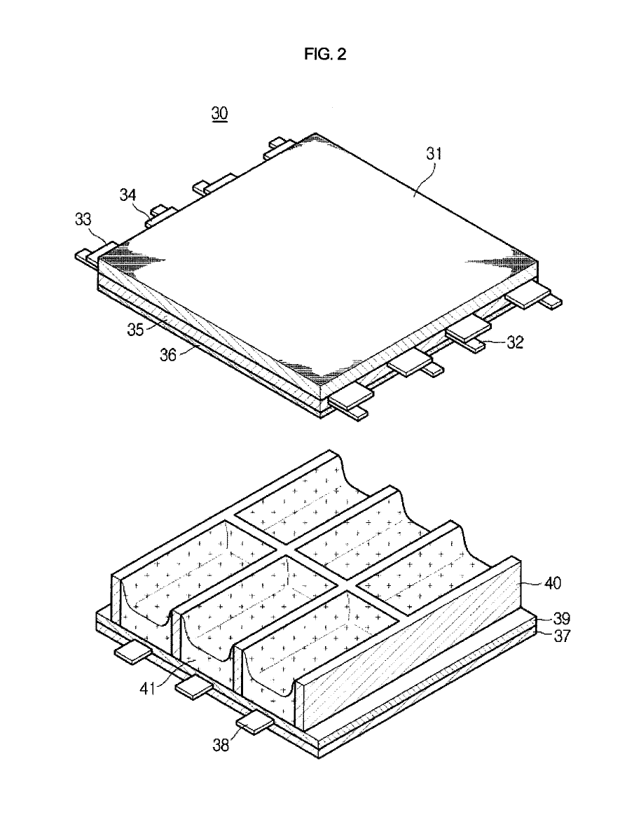

### DESCRIPTION OF THE PREFERRED EMBODIMENTS

Hereinafter, preferred embodiments of the present invention will be described in detail with reference to the attached drawings.

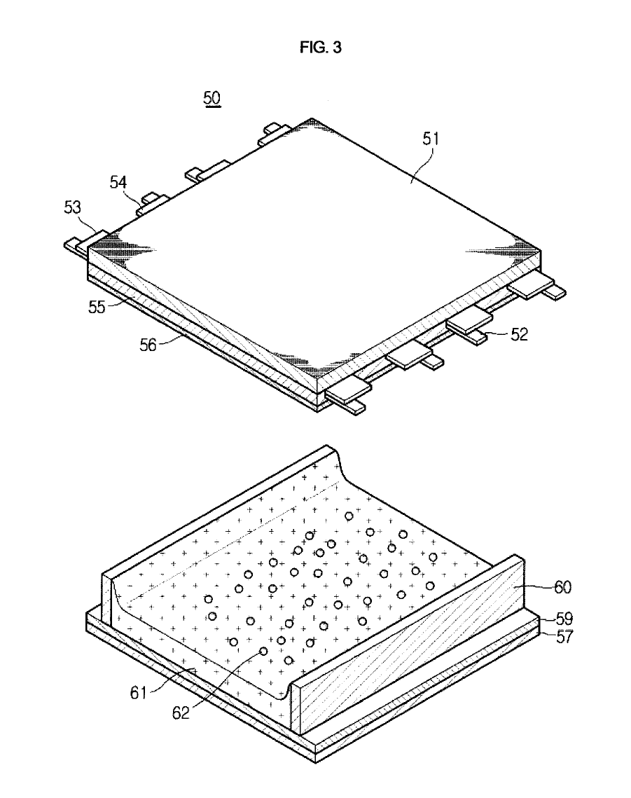

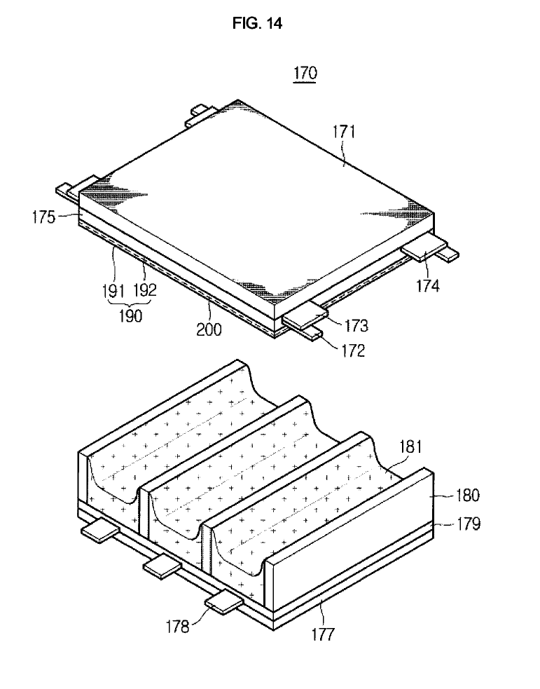

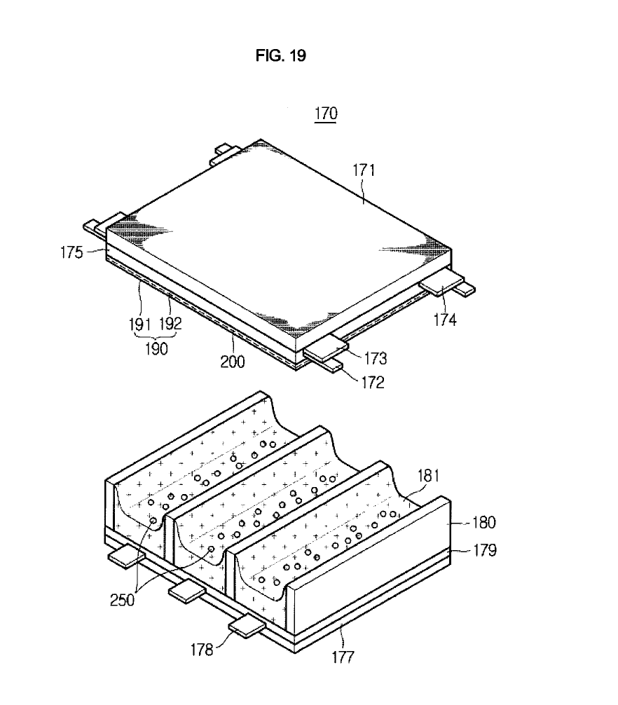

An AC plasma display panel including a phosphor layer provided with metal nanostructures will be described with reference to FIGS. 3 to 13, and an AC plasma display panel including a protective film provided with metal nanostructures will be described with reference to FIGS. 14 to 18. Further, an AC plasma display panel in which both a phosphor layer and a protective film are provided with metal nanoparticles will be described with reference to FIG. 19.

For reference, in the present invention, metal nanostructures may include metal nanoparticles, metal nanotubes, metal nanorods, metal nanowires and the like. The detailed description thereof is as follows.

First, an AC plasma display panel including a phosphor layer provided with metal nanostructures will be described with reference to FIGS. 3 to 13.

FIG. 3 is a perspective view showing an AC plasma lamp 50 including a phosphor layer 61 provided with metal nanoparticles 62 according to the present invention. FIG. 3 shows a structure in which metal nanoparticles 62 are deposited on a phosphor layer 61.

That is, as shown in FIG. 3, the AC plasma lamp 50 according to an embodiment of the present invention includes a front panel 51 and a rear panel 57, which are disposed in parallel to each other. The front panel 51 is provided with indium tin oxide (ITO) electrodes including bus electrodes 52, scan electrodes 53 and sustain electrodes 54. These electrodes are sequentially provided thereon with a dielectric layer 55 and a magnesium oxide (MgO) protective film 56 to form a front panel assembly.

The rear panel 57 is provided thereon with a dielectric layer 59, the dielectric layer 59 is formed thereon with partition walls 60, and a phosphor layer 61 is formed between partition walls 60 to form a rear panel assembly. In particular, the phosphor layer 61 is deposited thereon with metal nanoparticles 62.

Here, metals, such as gold, silver, nickel, aluminum, copper, iron and the like, and metal oxides, such as indium tin oxide and the like, may be used as the metal nanoparticles 62. These metal nanoparticles 62 may have a particle size of from several nanometers to several hundreds of nanometers and may have various shapes such as a sphere, tetrahedron, hexahedron, octahedron, bar column and the like. The phosphor layer 61 may be provided with metal nanoparticles having one single shape or mixtures of metal nonoparticles having different shapes.

In this AC plasma lamp 50, the front and rear panel assemblies are coupled and sealed, and then a discharge gas is charged in the combined panel assemblies to form a discharge space, thus causing lamp discharge.

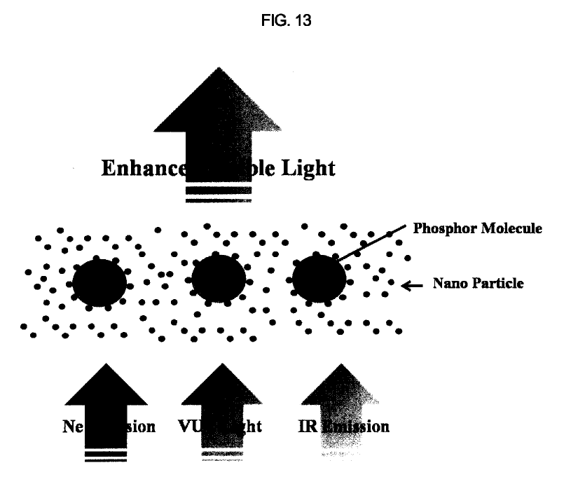

In this case, referring to FIG. 13 showing the interaction between the phosphor layer and metal nanoparticles, the AC plasma lamp 50 provided with the phosphor layer 61 including the metal nanoparticles 62 causes a surface plasmon resonance phenomenon around metal nanoparticles using light sources having various wavelengths, such as vacuum ultraviolet (VUV) and infrared (IR) generated from plasma discharge, visible ray of the phosphor itself, and the like, as an incident light source. The surface plasmon resonance phenomenon occurring around metal nanoparticles helps to induce a strong electric field to the region adjacent to metal nanoparticles and to increase the absorption strength and excitation strength of a phosphor. Moreover, the surface plasmon resonance phenomenon serves to decrease the time it takes the excited electrons of a phosphor to return to a ground state while generating photons, thus increase luminescent intensity.

Therefore, when the phosphor of the AC plasma lamp 50 is provided with metal nanoparticles 62, since the composition of the phosphor does not change, the luminescent characteristics of the phosphor can be improved while the phosphor is used as before, thus increasing the luminescent efficiency of an AC plasma display device.

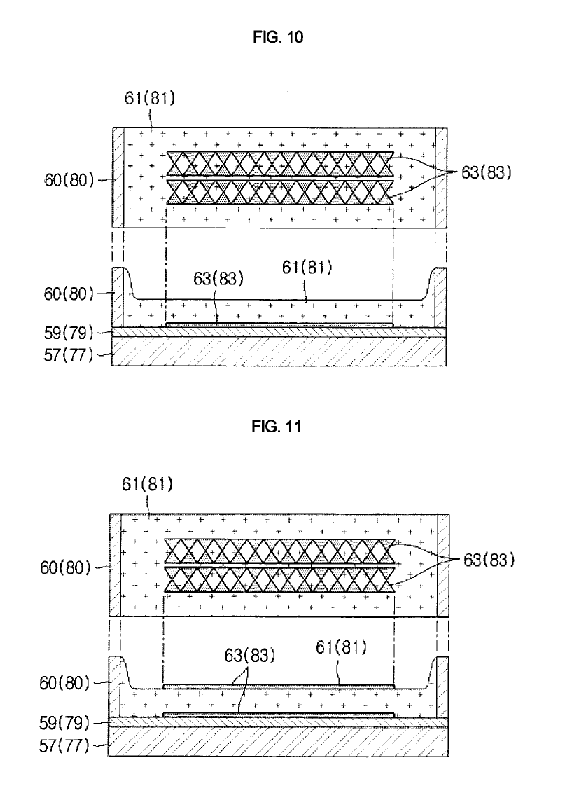

Meanwhile, in the embodiment, the phosphor layer is provided with metal nanoparticles 62, but it may be provided with metal nanostructures 63 (refer to FIG. 9) instead of metal nanoparticles 62.

Metal nanoparticles 62 have a grain shape and are irregularly or randomly arranged, whereas metal nanostructures 63 have the same shapes and are regularly arranged.

The shape and arrangement of metal nanostructures may be variously formed according to conditions. In this embodiment, as shown in FIGS. 9 to 12, the metal nanostructures having a triangular or reverse-triangular shape are continuously and regularly arranged.

These metal nanostructures 63 may be composed of the same materials as the above-mentioned nanoparticles 62, and may have a particle size of from several nanometers to several hundreds of nanometers.

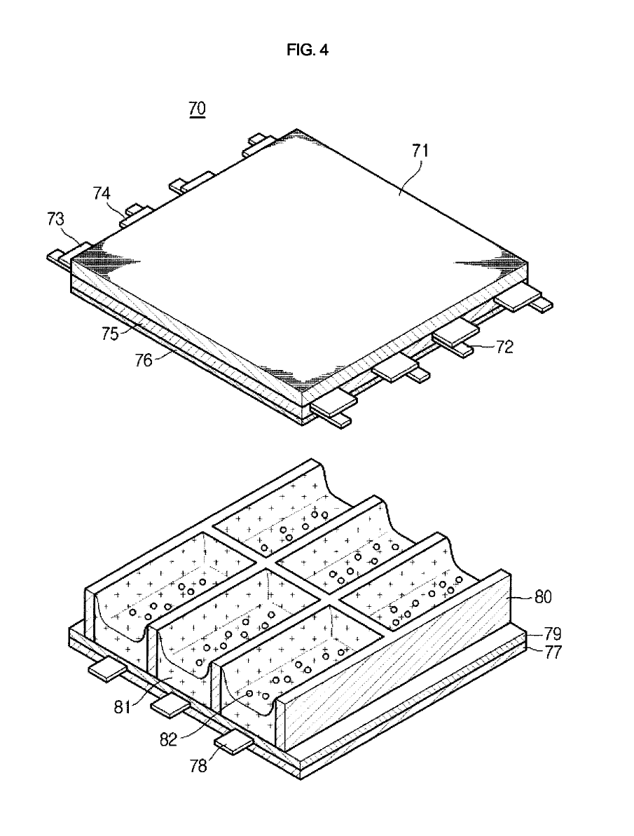

FIG. 4 is a perspective view showing an AC plasma display panel 70 having three kinds of electrodes, which includes a phosphor layer 81 provided with metal nanoparticles 81 according to the present invention. FIG. 4 shows a structure in which metal nanoparticles 82 are deposited on a phosphor layer 81, as shown in FIG. 3.

As shown in FIG. 4, the AC plasma display panel 70 according to an embodiment of the present invention includes a front panel 71 and a rear panel 77, similar to the above-mentioned AC plasma lamp 50.

The front panel 71, the same as the front panel 51 of the AC plasma lamp 50, is provided with indium tin oxide (ITO) electrodes including bus electrodes 72, scan electrodes 73 and sustain electrodes 74. These electrodes are sequentially provided thereon with a dielectric layer 75 and an oxide protective film 76 to form a front panel assembly.

However, the AC plasma display panel 70 is the same as the AC plasma lamp 50 in the point that the rear panel 77 is provided thereon with a dielectric layer 79, but is different from the AC plasma lamp 50 in the point that address electrodes 78 are disposed between the rear panel 77 and the dielectric layer 79. In this case, the address electrodes 78 are configured such that that they are at right angles to bus, scan and sustain electrodes 72, 73 and 74 provided in the front panel 71.

Further, the rear panel 77 is provided with partition walls 80 to form discharge microcells, and a phosphor layer 81 is formed between the partition walls 80. As in the AC plasma lamp 50, the phosphor layer 81 is deposited with metal nanoparticles 82. Further, as described above, the phosphor layer 81 may be provided with metal nanostructures 83 (refer to FIG. 9) instead of metal nanoparticles 82.

In this AC plasma display panel 70 of the present invention, the front panel 71 and rear panel 77 are assembled and sealed such that the scan and sustain electrodes 73 and 74 of the front panel 71 are at right angles to the address electrodes 78 of the rear panel 77, and then a discharge gas is charged in the assembled panels to form discharge spaces in every cell, thereby displaying desired images.

In this case, since the AC plasma display panel 70 of the present invention is also configured such that the phosphor layer 81 is deposited with metal nanoparticles 82, the luminescent characteristics of a phosphor are improved by the same principle as in the AC plasma lamp 50 of the present invention, thus improving the luminescent efficiency of the AC plasma display panel 70.

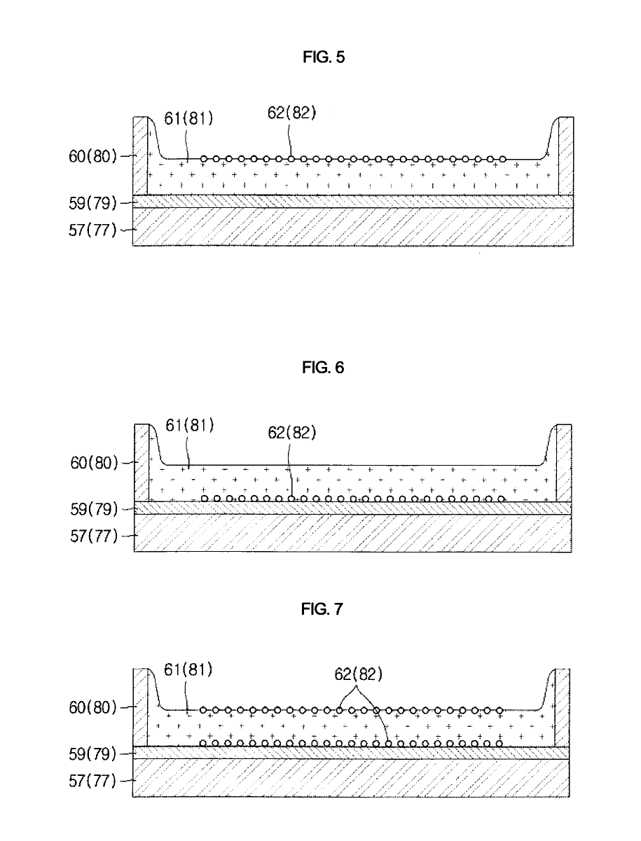

Hereinafter, preferred embodiments of each of the phosphor layers 61 and 81 provided with metal structures of the AC plasma lamp 50 and the AC plasma display panel 70 will be described. For reference, FIGS. 5 to 12 are sectional views showing the phosphor layers of the AC plasma lamp 50 according to the embodiments of the present invention. The phosphor layers of the AC plasma display panel 70 can also be configured the same as those of the AC plasma lamp 50 except for the address electrodes 78. Therefore, the reference numerals of the AC plasma lamp 50 and the AC plasma display panel 70 are described together.

FIGS. 5 to 8 are sectional views showing the phosphor layers 61 provided with metal nanoparticles 62 according to embodiments of the present invention, and FIGS. 9 to 12 are sectional views showing the phosphor layers 61 provided with metal nanostructures 63 according to embodiments of the present invention

First, FIGS. 5 to 8 show the structures in which the phosphor layers 61 and 81 of the AC plasma lamp 50 and the AC plasma display panel 70 are respectively provided with metal nanoparticles 62 and 82.

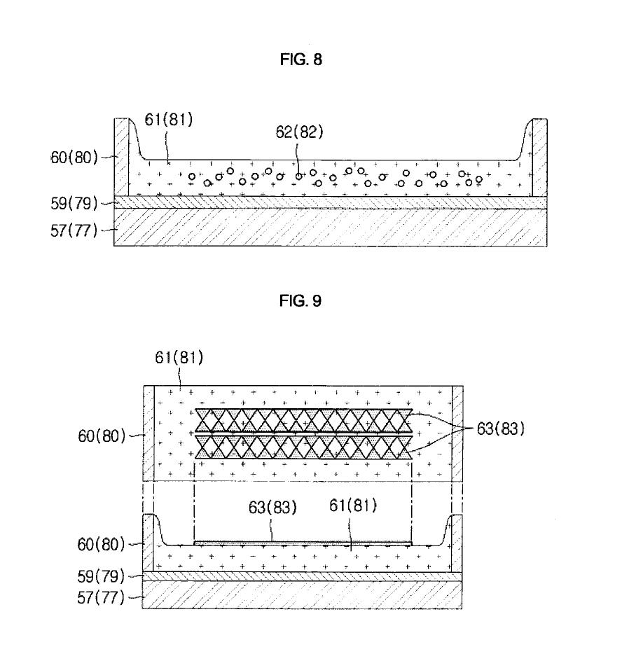

That is, FIG. 5 shows a structure in which a phosphor layer 61 is provided at the upper side thereof with metal nanoparticles 62, and FIG. 6 shows a structure in which a phosphor layer is provided at the lower side thereof, that is, between a dielectric layer and the phosphor layer with metal nanoparticles 62. Further, FIG. 7 shows a structure in which a phosphor layer is provided at both the upper and lower sides thereof with metal nanoparticles 62, and FIG. 8 shows a structure in which a phosphor layer is provided at the interior side thereof with metal nanoparticles 62 in a state in which the metal nanoparticles are mixed with a phosphor.

As described above, the metal nanoparticles 62 may be variously provided at the lower side of the phosphor layer 61, at the lower side thereof or at the interior side thereof.

Next, FIGS. 9 to 10 show the structures in which the phosphor layers 61 and 81 of the AC plasma lamp 50 and the AC plasma display panel 70 are respectively provided with metal nanostructures 63 and 83 instead of the metal nanoparticles 62 and 82.

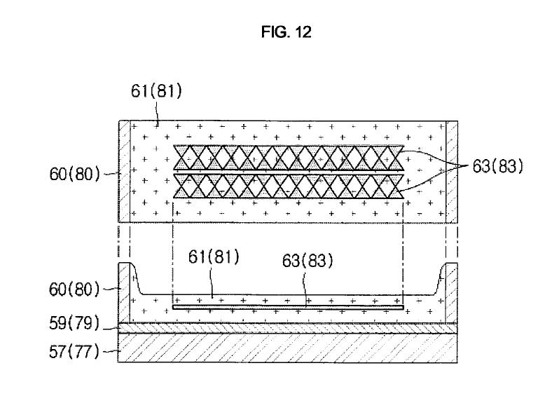

That is, FIG. 9 shows a structure in which a phosphor layer 61 is provided at the upper side thereof with metal nanostructures 63, and FIG. 10 shows a structure in which a phosphor layer is provided at the lower side thereof with metal nanostructures 63. Further, FIG. 11 shows a structure in which a phosphor layer is provided at both the upper and lower sides thereof with metal nanostructures 63, and FIG. 12 shows a structure in which a phosphor layer is provided at the interior side thereof with metal nanostructures 63.

In this case, as described above, it is preferred that the metal nanostructures 63 and 83 be configured such that they have the same shapes and are regularly arranged. These metal nanostructures 63 and 83, the same as the nanoparticles 62 and 82, help to improve the absorptive and luminescent characteristics of a phosphor and serve to decrease the life time of excited electrons and thus to improve the luminescent efficiency of the phosphor.

Subsequently, an AC plasma display panel including a protective film provided with metal nanostructures according to the present invention will be described with reference to FIGS. 14 to 18.

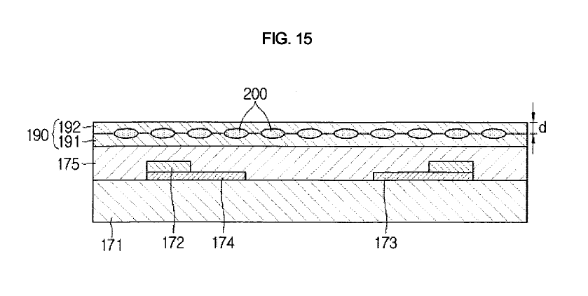

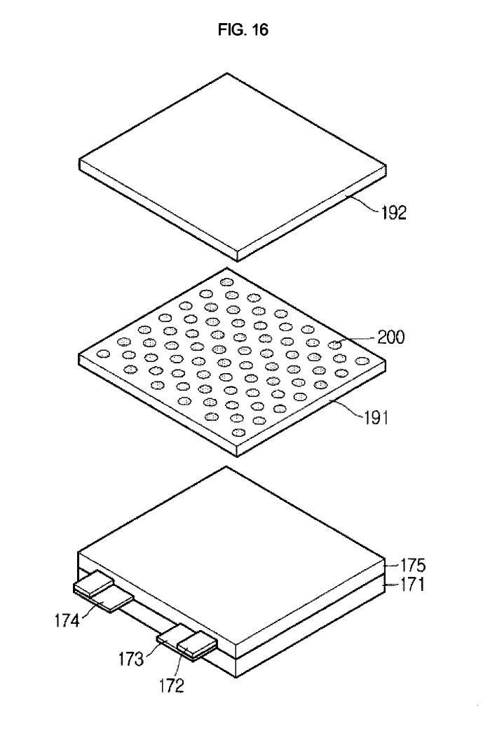

FIG. 14 is a perspective view showing an AC plasma display panel including a protective film provided with metal nanostructures according to the present invention, FIG. 15 is a sectional view showing a front panel including a protective film provided with metal nanostructures according to the present invention, and FIG. 16 is an exploded perspective view showing a front panel including a protective film provided with metal nanostructures according to an embodiment of the present invention.

As shown in FIG. 14, the AC plasma display panel including a protective film provided with metal nanostructures according to the present invention includes a front panel 171 and a rear panel 177, which face each other at a predetermined interval.

The front panel 171 is configured such that an electrode layer, a front dielectric layer 175 and a protective film 190 made of magnesium oxide (MgO) are sequentially disposed thereon. Here, the electrode layer may include bus electrodes 172 and transparent electrodes composed of a scan electrode 173 and a sustain electrode 174.

The rear panel 177 is configured such that address electrodes 178, a rear dielectric layer 179, partition walls 180 and a phosphor layer 181 are sequentially disposed thereon.

An inert gas, such as He, Ne, Xe, Ar or the like, is charged between the front panel 171 and the rear panel 177 to constitute a plasma display panel.

Since the structure of this plasma display panel is commonly known, the structure in which metal nanoparticles 200 are provided in the protective film 190 of the front panel is chiefly described.

The metal nanoparticles 200 may be made of Al or one or more transition metals selected from among Cu, Ag, Au, Ni, Pt, Co, Fe, Mn, Cr, Ti and Sc.

These metal nanoparticles 200 may have various shapes having a diameter of from several nanometers to several hundreds of nanometers, and may have the same area as that of a circle having a diameter of from several nanometers to several hundreds of nanometers.

The metal nanoparticles 200 may have various polyhedral shapes such as a sphere, tetrahedron, hexahedron, octahedron, cylinder, rod column, triangular column, and the like. The protective film 190 may be provided with metal nanoparticles having one single shape or mixtures of metal nanoparticles having different shapes.

In the present invention, since the protective film is configured such that the metal nanoparticles 200 are formed into a layer therein, the protective film includes a first protective film 191 formed on the front dielectric film 175, a nanoparticle layer disposed on the first protective film 191, and a second protective film 192 formed on the nanoparticle layer.

In this case, assuming that the value obtained by dividing the total area of the metal nanoparticles 200 distributed in the protective film 190 by the total area of the protective film 190 is defined as “coverage”, it is preferred that the coverage of the metal nanoparticles distributed between the first protective film 191 and the second protective film 192 be in a rage of 0.01 to 10%.

Further, it is preferred that the thickness (d) of the second protective film 192 be between 5 and 200 nm.

The kind and wavelength of the photon-causing surface plasmon excitation in the plasma display panel including the protective film 190 provided with the metal nanoparticles 200 are given in Table 1 below.

Table 1 shows the kind and wavelength of the photons generated from the unit cell of the plasma display panel using a Ne—Xe gas mixture.

TABLE 1

| Photons emitted from | | wavelength |
|---|---|---|
| a Ne-Xe gas mixture | | (nm) |
| Vacuum ultraviolet | | 147 |
| (VUV) | | 150 |
| | | 173 |
| Ne | | 640 |
| | | 703 |
| IR | | 823 |
| | | 828 |
| Visible ray | blue | 455 |
| | green | 525 |
| | red | 610 |

That is, photons, such as vacuum ultraviolet (VUV), Ne, infrared (IR), visible ray and the like generated from each discharge cell of the plasma display panel, can be used.

In a state in which the protective film 190 is additionally provided with the metal nanoparticles 200, when the above-mentioned photons are incident on the protective film 190 including the metal nanoparticles 200, the excitation of electrons is accelerated by the strong local field generated around the metal nanoparticles 200, thus increasing the secondary electron emission coefficient of the protective film 190. When the photons, such as vacuum ultraviolet (VUV), Ne, infrared (IR), visible ray and the like, which are generated from each discharge cell of the plasma display panel, are incident onto the metal nanoparticles such as Ag, Au and the like, a strong local field is generated around the metal nanoparticles by the interaction between the conduction electron spin resonance and the incident photons. The strength of this local field is increased compared to the size of the incident photon, and thus the excitation of the electrons around the metal nanoparticles 200 is accelerated. That is, the electron excitation induced by the photons influenced by the metal nanoparticles 200 of the protective film 190 synergizes with the electron excitation induced by the potential energy of ions, thus increasing the secondary electron emission coefficient.

Further, the nanoparticle layer, which is composed of the nanoparticles 200 and is formed in the protective film 190, functions to optically absorb the neon (Ne) and infrared (IR) generated at the time of plasma discharge and thus to store the energy generated from the plasma discharge in the metal nanoparticles and functions to increase the temperature of the region adjacent to the nanoparticle layer composed of the nanoparticles 200. Due to the increase in the temperature of the region adjacent to the nanoparticle layer, the secondary electron emission coefficient and the exo-electron emission rate are increased, thus decreasing an address delay time.

Hereinafter, a method of manufacturing an AC plasma display panel according to an embodiment of the present invention will be described with reference to FIGS. 14 to 17.

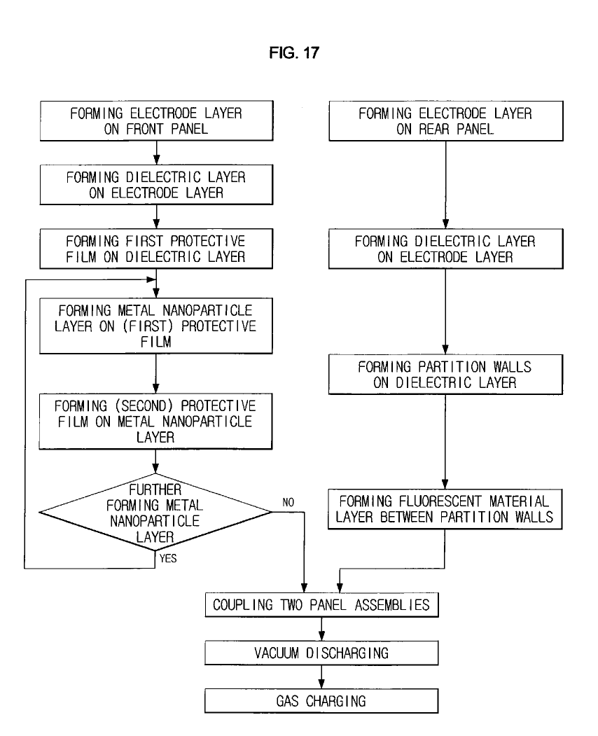

FIG. 17 is a flowchart showing a method of manufacturing an AC plasma display panel including a protective film provided with metal nanostructures according to an embodiment of the present invention.

In the method, the front panel 171 and the rear panel 177 are respectively fabricated.

First, the front panel 171 is coated with indium tin oxide (ITO) or tin dioxide (SnO₂) and then patterned through a photo-etching process to form transparent electrodes 173 and 174. Subsequently, the transparent electrodes 173 and 174 are coated with photosensitive silver (Ag) paste and then patterned through a photo-etching process to form bus electrodes 172 on the transparent electrodes 173 and 174. Thereafter, glass powder paste is printed on the front panel 171 such that the transparent electrode 173 and 174 and the bus electrode 172 are covered therewith through a screen printing process to form a transparent front dielectric layer 175.

Subsequently, the front dielectric layer 175 is deposited thereon with magnesium oxide (MgO) to form a first protective film 191. Thereafter, the first protective film 191 is dispersed thereon with metal nanoparticles 200 to form a nanoparticle layer. In this case, the nanoparticle layer is formed by dispersing the metal nanoparticles 200, such as Ag, Au, Cu, Al and the like, on the first protective film 191 in the form of colloid through a thermal evaporation method or an RF sputtering method.

After the nanoparticle layer is formed in this way, the nanoparticle layer is deposited thereon with MgO to form a second protective film 192, thereby completing a front panel assembly.

Meanwhile, a rear panel assembly may be formed through a conventional rear panel assembly fabrication method. The conventional method is as follows. First, a hole for gas charging and discharging, having a diameter of about 1 mm, is formed in a part of a rear panel 177, and then the rear panel 177 is printed thereon with photosensitive Ag paste and then patterned through a photo-etching process to form address electrodes 178. The address electrodes 178 are covered with a rear dielectric layer 179, and then partition walls 180 are formed on the rear dielectric layer 179. In this case, the rear dielectric layer may be formed using a sand blasting method, a squeezing method or a photo-etching method in addition to general screen printing methods. Subsequently, a phosphor layer 181 is formed between the partition walls 180. In this case, the phosphor layer 181 may be formed using a printing method, a pasting method in which a phosphor is exposed and etched by the addition of a photosensitive solvent, or an ink-jet method in which a phosphor pattern is formed by injecting ink containing a phosphor through an ink jet.

When the front panel assembly and the rear panel assembly are completed, they are combined with each other, and then a vacuum discharging process and a gas injecting process are conducted, thus fabricating a plasma display panel.

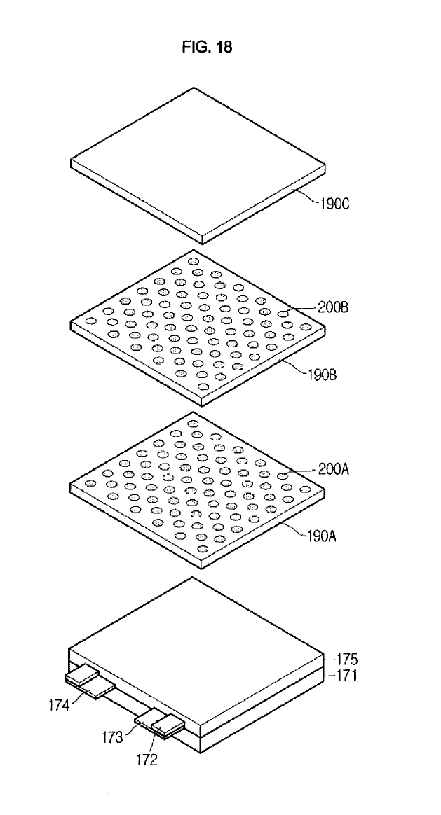

Meanwhile, FIG. 18 is an exploded perspective view showing a front panel assembly including a protective film provided with metal nanostructures according to another embodiment of the present invention. FIG. 18 shows a front panel assembly including a protective film in which a multi-layered nanoparticle layer is formed.

That is, as shown in FIG. 18, in this front panel assembly, a first protective film 190A is deposited thereon with first metal nanoparticles 200A to form a second protective film 190B, and then the second protective film 190B is deposited thereon with second metal nanoparticles 200B to form a third protective film 190C.

In this case, the first metal nanoparticles 200 A may be composed of the same metal as the second metal nanoparticles 200B, or may be composed of a metal different from that of the second metal nanoparticles 200B.

The multi-layered nanoparticle layer composed of metal nanoparticles 200 may be formed in various forms of one-layered to ten-layered depending on conditions.

Meanwhile, although not described through the drawings, the protective film 190 may be provided therein with metal nanostructures instead of the metal nanoparticles as shown in FIGS. 9 to 12.

Further, the protective film 190 provided with the metal nanoparticles 200 is used to manufacture not only just an AC plasma display panel but may also be used to manufacture an AC plasma lamp.

Further, in the embodiments of the present invention, the metal nanostructures are not only formed in the protective film or the phosphor layer, but, as shown in FIG. 19, may be formed in both the protective film and the phosphor layer.

For reference, FIG. 19 is a perspective view showing an AC plasma display panel in which both the phosphor layer 181 and protective film 190 are provided with metal nanoparticles 250. Here, the same reference numerals are used to designate the same components, and the repetitive description thereof is omitted

According to the AC plasma display device of the present invention, as shown in FIG. 19, the protective film 19 may be provided with the metal nanoparticles 200, and the phosphor layer 181 may also be provided with the metal nanoparticles 250. Moreover, the protective film 19 and the phosphor layer 181 may be provided with metal nanostructures instead of the metal nanoparticles 200.

The structure in which both the phosphor layer 181 and protective film 190 are provided with metal nanoparticles or metal nanostructures can be realized by modifying the structures of the embodiments described with reference to FIGS. 3 to 18.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An AC plasma display device using metal nanostructures, comprising:
a front panel and a rear panel which are disposed in parallel to each other and at least one of which is provided with electrodes for gas discharge;
an electrode layer, a front dielectric layer and a protective film which are sequentially formed on a side of the front panel which faces the rear panel;
a phosphor layer which is formed on the rear panel and which is excited and simultaneously radiated by gas discharge occurring in the electrodes; and
metal nanostructures included in the protective film and the phosphor layer.

2. An AC plasma display device using metal nanostructures, comprising a front panel and a rear panel disposed in parallel to each other,
wherein at least one of the front panel and the rear panel is provided with electrodes for gas discharge,
the rear panel is provided with a phosphor layer excited and simultaneously radiated by gas discharge occurring in the electrodes, and
the phosphor layer is provided with metal nanostructures for improving the luminescent characteristics of a phosphor.

3. The AC plasma display device according to claim 2, wherein the metal nanostructures are irregularly-arranged nanoparticles.

4. The AC plasma display device according to claim 2, wherein the metal nanostructures are regularly-arranged nanostructures.

5. The AC plasma display device according to claim 2, wherein the metal nanostructures are formed on the phosphor layer formed on a dielectric layer of the rear panel.

6. The AC plasma display device according to claim 2, wherein the metal nanostructures are formed between the dielectric layer and phosphor layer of the rear panel.

7. The AC plasma display device according to claim 2, wherein the metal nanostructures are formed both on the phosphor layer formed on a dielectric layer of the rear panel and between the dielectric layer and phosphor layer of the rear panel.

8. The AC plasma display device according to claim 2, wherein the metal nanostructures are formed in the phosphor layer in which the metal nanostructures are mixed with a phosphor.

9. An AC plasma display device using metal nanostructures, comprising:
a front panel and a rear panel which are spaced apart from each other at a predetermined interval and face each other and each of which is provided therein with discharge cells divided by partition walls; and
an electrode layer, a front dielectric layer and a protective film which are sequentially formed on a side of the front panel which faces the rear panel,
wherein the protective film is provided with metal nanostructures.

10. The AC plasma display device according to claim 9, wherein the metal nanostructures are made of Al or one or more transition metals selected from among Cu, Ag, Au, Ni, Pt, Co, Fe, Mn, Cr, Ti, Sc and combinations thereof.

11. The AC plasma display device according to claim 9, wherein the metal nanostructures have a diameter of from several nanometers to several hundreds of nanometers.

12. The AC plasma display device according to claim 9, wherein the metal nanostructures have a spherical or polyhedral shape, and the protective film is provided with metal nanostructures having any one of the spherical and polyhedral shapes or mixtures of metal nanostructures having the spherical or polyhedral shape.

13. The AC plasma display device according to claim 9, wherein a plurality of protective films is sequentially formed on the front dielectric layer, and nanoparticle layers in which metal nanoparticles are distributed are formed between the plurality of protective films.

14. The AC plasma display device according to claim 13, wherein the front dielectric layer is provided thereon with a first protective film, the first protective film is provided thereon with a nanoparticle layer in which metal nanoparticles are distributed, and the nanoparticle layer is provided thereon with a second protective film.

15. The AC plasma display device according to claim 9, wherein the metal nanostructures are distributed such that the value obtained by dividing the total area of the metal nanostructures distributed on the protective film by the total area of the protective film is in a range of 0.01 to 10%.

16. The AC plasma display device according to claim 9, wherein the nanoparticle layer composed of the metal nanostructures is configured such that the nanoparticle layer optically absorbs neon (Ne) and infrared (IR) generated at the time of plasma discharge and thus increases a temperature of a region adjacent to the nanoparticle layer to increase a secondary electron emission coefficient and exo-electron emission rate.

17. A method of manufacturing an AC plasma display device using metal nanostructures, in which discharge cells are formed by dividing a space between a front panel and a rear panel by partition walls, comprising the steps of:
sequentially forming an electrode layer and a front dielectric layer on the front panel;
forming a first protective film on the front dielectric layer;
forming a nanoparticle layer on the first protective film by distributing metal nanostructures thereonto; and
forming a second protective film on the nanoparticle layer.

18. The method of manufacturing an AC plasma display device according to claim 17, wherein, in the step of forming the nanoparticle layer, the nanoparticle layer is formed using any one of a thermal evaporation method and an an RF sputtering method.

19. The method of manufacturing an AC plasma display device according to claim 17, wherein, in the step of forming the nanoparticle layer, the metal nanostructures are distributed such that the value obtained by dividing the total area of the metal nanostructures distributed on the protective film by the total area of the protective film is in a range of 0.01 to 10%.

20. The method of manufacturing an AC plasma display device according to claim 17, wherein, after the step of forming the second protective film, the nanoparticle layer is formed into a multi-layered nanoparticle layer by repetitively performing the step of forming the nanoparticle layer and the step of forming the second protective film n times, thus improving a secondary electron emission coefficient using plasmon excitation.
